(19) United States
(12) Patent Application Publication
(10) Pub. No.: US 2010/0246798 A1
(43) Pub. Date: Sep. 30, 2010

(54) SYSTEM AND METHOD FOR DETERMINING A USER REQUEST

(75) Inventor: Kannan Ramamurthy, Novi, MI (US)

Correspondence Address: Julia Church Dierker;Dierker & Associates, P.C., 3331 W. Big Beaver Road, Suite 109, Troy, MI, 48084-2813, US

(73) Assignee: GENERAL MOTORS CORPORATION, Detroit, MI (US)

(21) Appl. No.: 12/412,328

(22) Filed: Mar. 26, 2009

(51) Int. Cl. H04M 3/00; G06K 9/62

(52) U.S. Cl. 379/265.09; 382/224

(57) ABSTRACT

A method for determining a user request involves receiving an image at a call center and generating a mathematical representation associated with the image. The method further includes using the image mathematical representation and a pre-selected image mathematical representation (previously associated with an action) to identify a user request that is associated with the image. Also disclosed herein is a system for accomplishing the same.

### TECHNICAL FIELD

The present disclosure relates generally to systems and methods for determining a user request.

### BACKGROUND

Subscriber requests for services and/or information are often submitted to a call center, verbally, via text messaging, actuating a button associated with an action (e.g., on a key fob), or the like. For example, if a subscriber desires a door unlock service from the call center, he/she may, e.g., place a telephone call to the call center and verbally submit the request to a call center advisor.

### SUMMARY

A method for determining a user request is disclosed herein. The method includes receiving an image at a call center and generating a mathematical representation associated with the image. A previously stored mathematical representation associated with a pre-selected image is retrieved, where the pre-selected image corresponds to an action. The method further includes using the image mathematical representation and the pre-selected image representation to identify a user request that is associated with the image. Also disclosed herein is a system for accomplishing the same.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for determining a user request;

FIG. 2 is a flow diagram depicting a method for determining a user request;

FIGS. 3A and 3B each depict an example of a remotely accessible page for use in examples of the method and system disclosed herein; and

FIG. 4 is a flow diagram depicting an example of a method for identifying the user request.

### DETAILED DESCRIPTION

With the advent of camera phones and other similar tele-imaging devices, picture messaging has been introduced as a viable telecommunication means between persons and/or entities. Picture messaging may, for example, be used to quickly relay a communication (in the form of an image) to a desired recipient without having to engage in lengthy and/or economically expensive telephone calls, e-mails, or the like. The term “picture messaging” refers to a process for sending, over a cellular network, messages including multimedia objects such as, e.g., images, videos, audio works, rich text, or the like. Picture messaging may be accomplished using “multimedia messaging service” or “mms”, which is a telecommunications standard for sending the multimedia objects.

Example(s) of the method and system disclosed herein advantageously uses picture messaging as a means for determining a subscriber's request for information and/or services from a call center. In other words, an image may be submitted to the call center and may be used, by the call center, to determine an action associated with the subscriber's request. The action generally includes providing, to the subscriber or user, at least one of vehicle information, vehicle diagnostics, or other vehicle or non-vehicle related services. The submission of the image and the determining of the request from the image may advantageously enable the subscriber to submit his/her request and/or enable the call center to fulfill the request regardless of any potential language barrier between the subscriber and an advisor at the call center. Additionally, in some instances, the fulfilled request may be submitted to the subscriber, from the call center, in a format suitable for viewing by the subscriber's mobile telephone or other similar device. Furthermore, the example(s) of the method and system described hereinbelow enable relatively fast request submissions and request fulfillments, where such submissions and/or fulfillments tend to be economically cheaper than other means for submitting and/or fulfilling subscriber requests.

It is to be understood that, as used herein, the term “user” includes vehicle owners, operators, and/or passengers. It is to be further understood that the term “user” may be used interchangeably with subscriber/service subscriber.

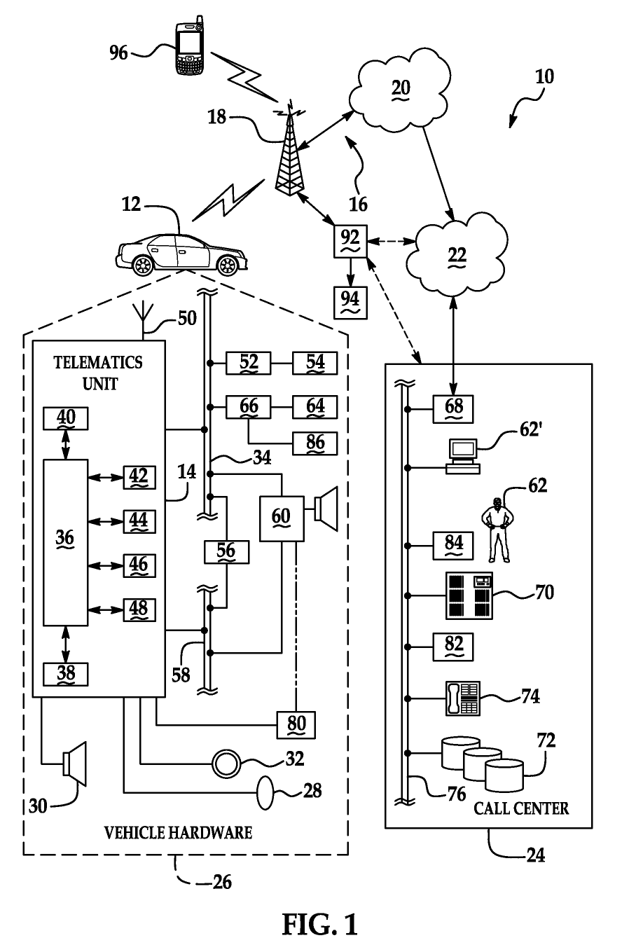

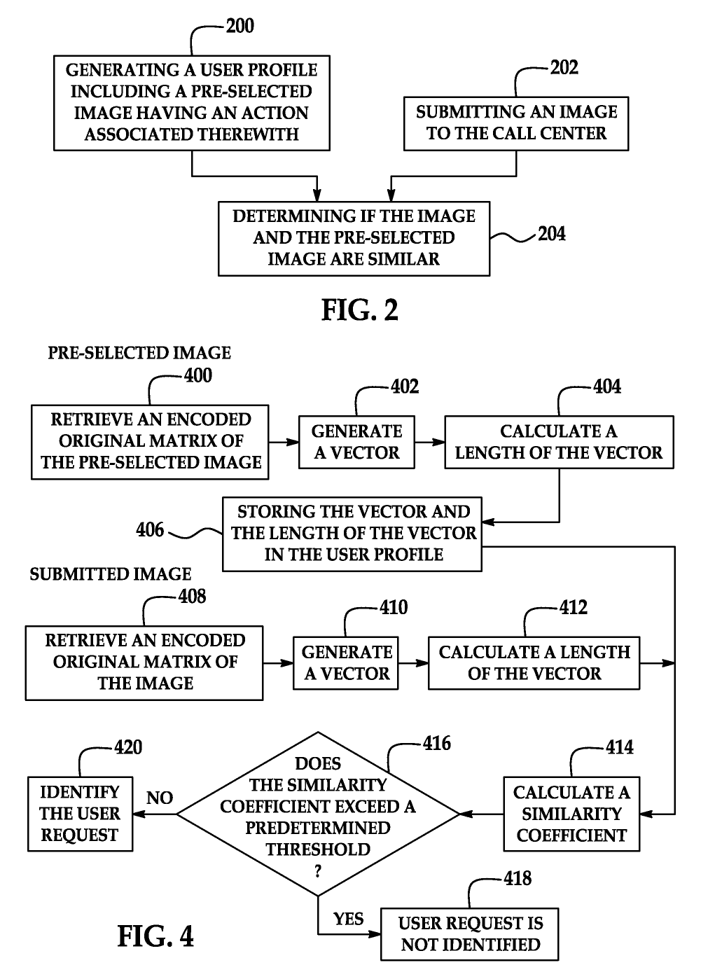

As used herein, the term “image” includes a picture, an illustration, or another visual representation of an object. In some instances, an image includes one or more features, examples of which include color, brightness, contrast, and combinations thereof As will be described in further detail below, at least in conjunction with FIG. 2, the image is configured to be transmittable from a remote device (e.g., a cellular phone, a camera phone, etc.) 96 to the call center 24 (both shown in FIG. 1), and visa versa.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

It is to be further understood that “communication” is to be construed to include all forms of communication, including direct and indirect communication. As such, indirect communication may include communication between two components with additional component(s) located therebetween.

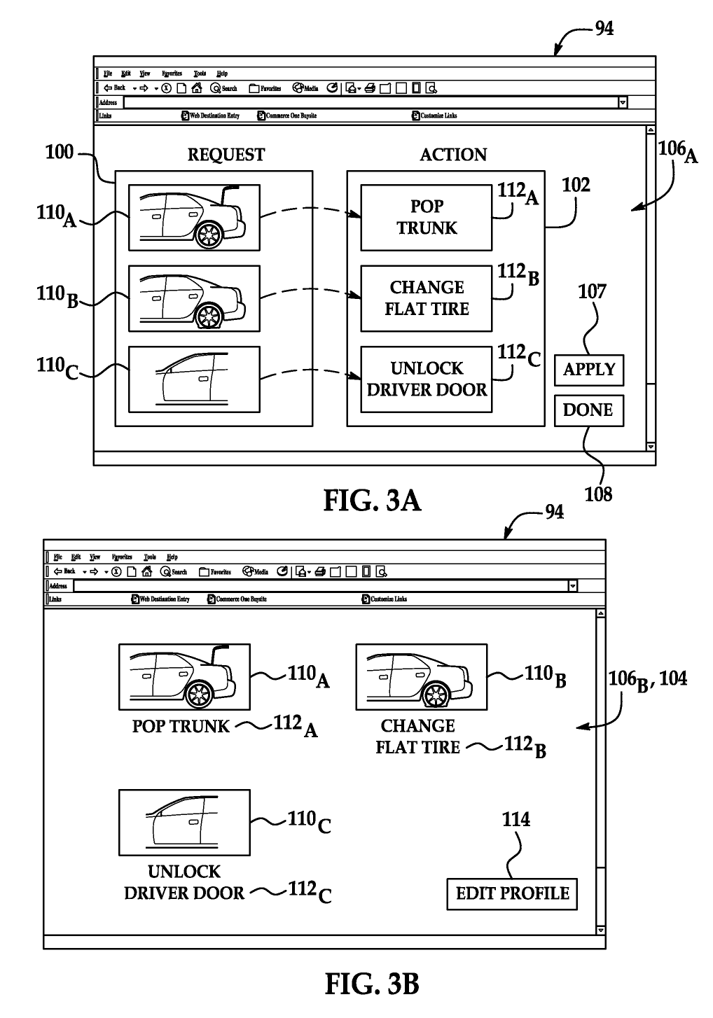

Referring now to FIG. 1, the system 10 includes a vehicle 12, a telematics unit 14, a wireless carrier/communication system 16 (including, but not limited to, one or more cell towers 18, one or more base stations and/or mobile switching centers (MSCs) 20, and one or more service providers (not shown)), one or more land networks 22, and one or more call centers 24. In an example, the wireless carrier/communication system 16 is a two-way radio frequency communication system. In another example, the wireless carrier/communication system 16 includes one or more servers 92 operatively connected to a remotely accessible page 94 (e.g., a webpage). An example of the remotely accessible page 94 will be described in further detail below in conjunction with FIGS. 3A and 3B.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicle 12 is a mobile vehicle such as a motorcycle, car, truck, recreational vehicle (RV), boat, plane, etc., and is equipped with suitable hardware and software that enables it to communicate (e.g., transmit and/or receive voice and data communications) over the wireless carrier/communication system 16. It is to be understood that the vehicle 12 may also include additional components suitable for use in the telematics unit 14.

Some of the vehicle hardware 26 is shown generally in FIG. 1, including the telematics unit 14 and other components that are operatively connected to the telematics unit 14. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies such as TDMA (time division multiple access), CDMA (code division multiple access) and GSM (global system for mobile telecommunications). In some instances, the protocol may be a short-range wireless communication technologies, such as BLUETOOTH®, dedicated short-range communications (DSRC), or Wi-Fi.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein, and is configured to fulfill one or more user or subscriber requests. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications generally utilize radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, environmental detection sensors, and/or the like. One or more of the sensors 64 enumerated above may be used to obtain the vehicle data for use by the telematics unit 14 or the call center 24 to determine the operation of the vehicle 12. Non-limiting example sensor interface modules 66 include powertrain control, climate control, body control, and/or the like.

In a non-limiting example, the vehicle hardware 26 includes a display 80, which may be operatively directly connected to or in communication with the telematics unit 14, or may be part of the audio component 60. Non-limiting examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 16 may be a cellular telephone system or any other suitable wireless system that transmits signals between the vehicle hardware 26 and land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions. The call center 24 is further configured to receive an image corresponding to a user request and to fulfill the user request upon identifying the request. According to the example shown here, the call center 24 generally includes one or more switches 68, servers 70, databases 72, live and/or automated advisors 62, 62′, a processor 84, as well as a variety of other telecommunication and computer equipment 74 that is known to those skilled in the art. These various call center components are coupled to one another via a network connection or bus 76, such as one similar to the vehicle bus 34 previously described in connection with the vehicle hardware 26.

The processor 84, which is often used in conjunction with the computer equipment 74, is generally equipped with suitable software and/or programs configured to accomplish a variety of call center 24 functions. In an example, the processor 84 uses at least some of the software to i) determine a user request, and/or ii) fulfill the user request. Determining and/or fulfilling the user request will be described in further detail below in conjunction with FIGS. 2-4.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or the automated response system 62′, and data transmissions are passed on to a modem or other piece of equipment (not shown) for demodulation and further signal processing. The modem preferably includes an encoder, as previously explained, and can be connected to various devices such as the server 70 and database 72. For example, database 72 may be designed to store subscriber profile records, subscriber behavioral patterns, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

A cellular service provider generally owns and/or operates the wireless carrier/communication system 16. It is to be understood that, although the cellular service provider (not shown) may be located at the call center 24, the call center 24 is a separate and distinct entity from the cellular service provider. In an example, the cellular service provider is located remote from the call center 24. A cellular service provider provides the user with telephone and/or Internet services, while the call center 24 is a telematics service provider. The cellular service provider is generally a wireless carrier (such as, for example, Verizon Wireless®, AT&T®, Sprint®, etc.). It is to be understood that the cellular service provider may interact with the call center 24 to provide various service(s) to the user.

Examples of the method for determining a user request are described hereinbelow in conjunction with FIGS. 2-4. Referring now to FIG. 2, an example of the method very generally includes: generating a user profile, the profile including a pre-selected image having an action associated therewith (as shown by reference numeral 200); submitting an image to the call center 24 (as shown by reference numeral 202); and determining if the image and the pre-selected image are similar (as shown by reference numeral 204). In instances where the image and the pre-selected image are considered to be similar, an action corresponding with the user request may be identified by the call center 24 and ultimately used to fulfill the user request.

The user profile (identified by reference numeral 104 in FIG. 3B) is a report or record including personal information of a particular user. The profile 104 may include the user's name, address, vehicle information, telematics service information (e.g., length of contract, total number of calling minutes/units purchased and/or remaining, etc.), etc. In the embodiments disclosed herein, the profile 104 also includes a plurality of pre-selected images, each having an action associated therewith. In an example, pre-selected image portion of the profile 104 is generated when an image is selected (i.e., the image becomes the pre-selected image), an action is associated with the pre-selected image, and the pre-selected image and the associated action are stored electronically (or by other suitable means). This example of the method for generating the user profile 104 (specifically the profile 104 including the pre-selected image portion) will be described in further detail hereinbelow in conjunction with examples of the remotely accessible page 94 (referred to below as the “webpage 94”) depicted in FIGS. 3A and 3B.

Referring now to FIG. 3A, the pre-selected image may be selected from a plurality of images provided in a request box 100 on the webpage 94. In some instances, the request box 100 may include a number of standard images that a user or subscriber may select and associate with a particular action. Such standard images may include computer-generated graphical representations of various objects, photographs (e.g., uploaded via the operator of the webpage 94, retrieved from other websites, etc.), and/or the like. In other instances, the request box 100 may otherwise include images uploaded to the website by the user. Such uploaded images may include photographs, scanned images of hand-sketches or other graphical representations of various objects, and/or the like. In yet other instances, the request box 100 may include both standard images and uploaded images. For example, the request box 100 may include an uploaded photograph of a vehicle door, a standard graphical representation of a vehicle door, and/or the like.

The pre-selected image portion of the user profile 104 (shown in FIG. 3B) may be generated by selecting one of the images provided in the request box 100 and associating the selected image with an action. As used herein, an “action” refers to an act that the call center 24 is capable of performing or initiating in order to fulfill a particular user request. Non-limiting examples of actions include providing vehicle information to the subscriber (such as, e.g., information related to the make, model, and/or year of the subscriber's vehicle 12, etc.), providing a vehicle service (such as, e.g., locking/unlocking vehicle doors, providing emergency help for a stalled vehicle 12, providing directions/navigation instructions, etc.), and providing vehicle diagnostics (such as, e.g., if the vehicle 12 needs gasoline, if the vehicle 12 needs maintenance, determining remaining oil life in the vehicle 12, determining the pressure level of the tires of the vehicle 12, etc.).

The image selected from the request box 100 and associated with an action is referred to herein as “a pre-selected image”. In the example shown in FIG. 3A, three pre-selected images are shown in the request box 100, namely an image of an open trunk 110_{A}, an image of a flat tire 110_{B}, and an image of a driver's side car door 110_{C}. The user, when generating the image portion of the user profile 104, may select an action provided in an action box 102 and associate the pre-selected image 110_{A}, 110_{B}, 110_{C} with a particular action. The actions may be provided as separate icons in the action box 102 (e.g., “POP TRUCK” action 112_{A}, “CHANGE FLAT TIRE” action 112_{B}, and “UNLOCK DRIVER DOOR” action 112_{C}, as shown in FIG. 3A). In other examples, the actions may be selected from a drop-down box provided in the action box 102, may be retrieved from another webpage associated with the webpage 94, may be generated by the user, and/or the like, and/or combinations thereof.

In the example shown in FIG. 3A, the user selects a pre-selected image and associates the pre-selected image with a desired action by dragging the image across the webpage screen 106_{A} and dropping the image onto the icon representing the desired action. For instance, if the pre-selected image is the open trunk 110_{A}, the user drags the image and drops the image onto the “POP TRUNK” icon 112_{A}.

In some instances, the pre-selected image may be selected from an image that is cognitively associated with the desired action. As shown in the example above, the image of the opened vehicle trunk identified by reference numeral 110_{A} may be associated with the “POP TRUNK” action identified by reference numeral 112_{A}. It is to be understood, however, that the pre-selected image may be any image, not necessarily cognitively associated with the desired action. For example, the pre-selected image could be a photograph of a water bottle, and the water bottle may be associated with the “POP TRUNK” action 112_{A}. In another example, the pre-selected image may be a photograph of a driver side car door (such as the image shown by reference numeral 110_{C} in FIG. 3A), and the driver side car door image 110_{C} may be associated with the “POP TRUNK” action 112_{A}.

It is further to be understood that a pre-selected image may be associated with one or more actions, and visa versa. For example, the image of the open trunk 110_{A} may be associated with both the “POP TRUNK” action 112_{A} and the “UNLOCK DRIVER DOOR” action 112_{C}. In another example, the image of the open trunk 110_{A} and the driver side car door 110_{C} may both be associated with the “POP TRUNK” action 112_{A}.

After the user has associated the pre-selected image with a desired action, the user may select (via, e.g., a mouse click, a finger touch if a touch screen is available, or other similar action) the “APPLY” button 107 on the webpage screen 106_{A} to set the new association. After setting, the user may then select the “DONE” button 108 to finish.

When generating the pre-selected image portion of the user profile 104, the user logs into the webpage 94 to access a previously created profile 104, or generates a new profile 104 via the webpage 94. When accessing a previously created profile 104 to create or revise the pre-selected image portion, the user may be prompted for verification information to ensure he/she is an authorized user of account. When the input verification information matches previously stored verification information, the user is granted access. In many instances, the call center 24 will generate the original profile 104 (including personal information and vehicle information) when the user becomes a subscriber of the telematics services, and then the user will create the pre-selected image portion of the profile via the webpage 94. However, in some instances, the user may sign up for telematics services via the webpage 94. In such instances, the user generates a new profile 104, and he/she may be prompted for personal information to create the profile 104 and then may be prompted to generate a login and password for obtaining future access. The user may create the pre-selected image portion of the profile 104 during the same session as the profile 104 generation, or may gain access at a later time.

An example of the generated pre-selected image portion of the user profile 104 is generally shown in the website screen 106_{B} in FIG. 3B. The user profile 104 may, for example, include a list of the pre-selected images (e.g., 110_{A}, 110_{B}, 110_{C}) and the action(s) (e.g., 112_{A}, 112_{B}, 112_{C}) associated with the images. As shown in FIG. 3B, the pre-selected image portion user profile 104 includes i) the image of the open trunk 110_{A} associated with the “POP TRUNK” action 112_{A}, ii) the image of the flat tire 110_{B} associated with the “CHANGE FLAT TIRE” action 112_{B}, and iii) the image of the driver side car door 110_{C} associated with the “UNLOCK DRIVER DOOR” action 112_{C}.

The user profile 104 (including the pre-selected image portion) is generally uploaded to and stored in one of the databases 72 at the call center 24. As such, the generated profile 104 is accessible by the call center 24 and by the user via the webpage 94. The generated user profile 104 may be accessed by the user using any device capable of accessing the Internet, on which the webpage 94 is available. As mentioned hereinabove, the user may be authenticated and/or verified prior to actually accessing the webpage 94. Authentication and/or verification may be accomplished by requesting the user to provide a personal identification number (PIN), a login name/number, and/or the like, accompanied with a password. In some instances, the user may also be presented with one or more challenge questions if, e.g., the user is using an unrecognized computer or other device for accessing the Internet. Non-limiting examples of challenge questions may include various questions related to, e.g., the user's mother's maiden name, the user's father's middle name, the user's city of birth, etc. In instances where i) the user provides the wrong identification code and/or password, and/or ii) answers one or more of the challenge questions incorrectly, the webpage 94 will deny access to the user profile 104.

In instances where the user is verified and/or authenticated, the user is then able to access the webpage 94. Upon such access, the user is presented with the webpage screen 106_{B} showing the user profile 104. The user may elect to edit his/her profile by selected the “EDIT PROFILE” button 114 at the bottom of the webpage screen 106_{B} (FIG. 3B). The user will then be presented with the webpage screen 106_{A} (FIG. 3A), where he/she will be able to upload/select one or more new pre-selected images and associate the one or more new pre-selected images with one or more actions. When the user is finished (i.e., when the user has selected the “APPLY” button 107 and then the “DONE” button 108), the user profile 104 is updated, and then uploaded to and stored at the call center 24. In an example, the updated profile 104 is automatically uploaded to the call center 24 when the updating is complete (i.e., when the user selects the “DONE” button 108). In some instances the user may be prompted (by, e.g., a dialogue box), notifying the user that the profile 104 has in fact been uploaded. In another example, after the profile 104 has been updated, the user will be prompted (by, e.g., a dialogue box that appears on the screen 106_{B}), asking the user is he/she would like to upload the profile 104 at the call center 24. If the user decides that he/she wants the profile 104 uploaded, upon selecting the appropriate command (e.g., a “YES” button associated with the dialogue box), the profile 104 will be automatically uploaded at the call center 24. If, however, the user decides that he/she does not want the profile 104 uploaded, he/she will indicate the same by selecting the appropriate command (e.g., a “NO” button associated with the dialogue box) and the profile 104 will be stored at the user's workstation. The profile 104 may be retrieved by the user and uploaded at the call center 24 at a later time.

The pre-selected images stored in the user profile 104 are used, by the call center 24, to ultimately determine a user request. In an example, the user request may be determined by generating a mathematical representation associated with the pre-selected image, generating a mathematical representation associated with an image received by the call center 24, and identifying the user request using the mathematical representations from both the pre-selected image and the received image. More specifically, the mathematical representations are used to determine a similarity coefficient, which may then be used to determine if the images are similar. In the event that the images are in fact similar, the call center 24 may deduce the user request associated with the received or submitted image and apply the action associated with the pre-selected image that is similar to the submitted image.

The method of generating the mathematical representation associated with the pre-selected image will now be described in conjunction with FIG. 4. The method will be described herein using the open trunk image 110_{A} as the pre-selected image. It is to be understood, however, that the method may also be used to generate the mathematical representation for any pre-selected image.

Referring now to FIG. 4, the mathematical representation associated with the pre-selected open trunk image 110_{A} may be generated (e.g., by the processor 84 at the call center 24) by retrieving an encoded original matrix of the pre-selected open trunk image 110_{A} (as shown by reference numeral 400), generating a vector based on the encoded original matrix (as shown by reference numeral 402), and calculating a length of the vector (as shown by reference numeral 404). In an example, the encoded original matrix is retrieved from the pre-selected image 110_{A} file type, such as, e.g., a JPEG file or the like.

The term “JPEG” (an acronym for Joint Photographic Experts Group) generally refers to a compression method for an image, where the degree of compression may be adjusted based on desired storage size, image quality, and/or the like. JPEG is also considered a lossy data compression method, whereby some information may be removed from the image upon compression thereof. It is to be understood that removal of such information, for all intents and purposes for which the image is used in the instant disclosure, is generally not detrimental to the final image product or the resulting matrices and vectors. Upon saving the pre-selected image 110_{A} in a JPEG format, the image 110_{A} is encoded using a variant of a Huffman encoding process and a matrix Q is generated therefrom. The matrix Q may be used to deduce the mathematical representation of the pre-selected image 110_{A} in the form of a vector.

The matrix Q from the reconstruction of the image 110_{A} represents a bit stream and having embedded therein a JPEG resolution of the pre-selected image 110_{A}. Generally, the embedded resolution is rated on a quality level scale ranging from 1 to 100 (i.e., where 1 is the poorest quality). The image quality should generally meet specific minimum criteria in order for the mathematical representation to be generated from the image 110_{A}. The minimum criteria generally include a minimum resolution of the image. In one non-limiting example, the minimum resolution of the image is about 128 pixels.

The matrix Q is then quantized because the original pre-selected image 110_{A} may have undergone varying levels of image compression and quality when received. Quantization of the matrix Q is accomplished using a JPEG standard quantization matrix M, and the JPEG standard quantized matrix M used will depend, at least in part, on a quantization divisor assigned to the received pre-selected image 110_{A}. The quantization divisor corresponds to an embedded resolution value. As previously discussed, the embedded resolution, and thus the quantization divisor, ranges from 1 to 100. Since the matrix Q is quantized using the standard JPEG quantization matrix M, another matrix T is generated by multiplying each element in matrix M by the corresponding element of the matrix Q. As generally used in most JPEG encoding processes, the formation of the matrix T may be represented by the following mathematical expression:

Tᵢⱼ=Mᵢⱼ*Qᵢⱼ (Eqn. 1)

where the subscripts “i” and “j” refer to integer indices into the matrices.

The discrete cosine transform function (DCT, which is generally known in the art) is used on the matrix T to obtain yet another matrix A. This other matrix A is a matrix of AC/DC coefficients, which is a new matrix of the same dimension.

Finally, the number 128 is added to each element of matrix A, which represents half of the maximum number of possibilities for a pixel for an 8-bit image.

Once the matrix A is generated, the pre-selected image 110_{A} is decoded and the original matrix Q is obtained. Decoding may be accomplished using the inverse of the encoding functions (e.g., the inverse discrete cosine transfer function, the divisors are used as multipliers, etc.). This process may be referred to herein as the JPEG decoding process.

In some instances, a disambiguation process/technique may be performed on the matrix A prior to decoding. The disambiguation process/technique may, for example, be embodied into a singular value decomposition (an algorithm used in the linear algebra for deriving singular values for a matrix).

The mathematical representation (i.e., the vector) associated with the pre-selected image 110_{A} may be generated using the encoded original matrix Q. Once the vector has been generated for the pre-selected image 110_{A}, the length (or magnitude) and the direction of the vector may be calculated (as shown by reference numeral 404 in FIG. 4). In an example, the length of the vector may be calculated by calculating the distance from one end of the vector (x₁,y₁,z₁) to the other end of the vector (x₂,y₂,z₂). The vector and its components (magnitude and direction) of the vector are both stored in the user profile 104 (as shown by reference numeral 406). When stored in the user profile 104, the vector and the length of the vector are associated with the appropriate pre-selected image (the pre-selected image 110_{A}, as used for this example).

Referring back to FIG. 2, an image is submitted by the user to the call center 24 (as shown by reference numeral 202) when the user desires a particular action from the call center 24, such as, e.g., vehicle information, a vehicle service, and/or vehicle diagnostics. As used herein, the “image” is a photograph or other digital graphical representation that may be submitted by the user to the call center 24 using a suitable device. In an example, the user obtains the image and uses the remote device 96 (shown in FIG. 1) to submit the image to the call center 24. The remote device 96 may be any device having telecommunication services capable of transmitting and/or receiving multimedia objects. Non-limiting examples of the remote device 96 include cellular phones having Internet access, cellular phones having a camera or other imaging technology associated therewith, personal digital assistants (PDA) having wireless transmission capabilities, personal computers, and/or the like, and/or combinations thereof. The image may be obtained, for example, by capturing the image as a digital photograph using the remote device 96. In instances where the remote device 96 is a camera phone or has image taking capabilities, the image may be captured by the camera phone and the captured image may be transmitted to the call center 24 from the same remote device 96. In instances where the remote device 96 does not have picture taking capabilities, the image may be captured by a camera (e.g., a digital camera) and uploaded onto a device such as a personal computer. In other instances, the image may be scanned into the personal computer. In any event, the uploaded/scanned image may then be attached to an e-mail or other suitable means and transmitted from the remote device 96 to the call center 24.

In some instances, the image submitted to and received by the call center 24 includes user identification information associated with the subscriber's vehicle 12. The user identification information may include, for example, a personal identification number (PIN) or other code sufficient to identify the vehicle 12 for which the request will be fulfilled. The user identification information may, in an example, be sent to the call center 24 as a text message separate from, but concurrently with the image. In another example, the identification information may be sent to the call center 24 as meta data along with the image. For instance, the identification information may be included on the image, as a header, for example, at the time the image is submitted to the call center 24.

In other instances, the image submitted to and received by the call center 24 does not include user identification information associated with the subscriber's vehicle 12. In these instances, upon receiving the image, the call center 24 requests, from the sender of the image, user identification information. Requesting such information may be accomplished by pinging the sender of the image (via a text message, phone call, etc.). In response to the request, the sender of the image transmits his/her user identification information to the call center 24. The call center 24 uses the transmitted user identification number to identify the vehicle 12 corresponding to the image, and for which the request will be fulfilled.

It is to be understood that the image sent to and received by the call center 24 signifies a user request. The user request may be identified, by the call center 24, by extracting/identifying the user request from a match of the image with one of the pre-selected images stored in the user profile 104. Matching may be accomplished by determining whether or not the image and the pre-selected image are similar. It is to be understood that, in many instances, a perfect match may not occur. However, in such instances, images that are similar to (within a predetermined threshold) a pre-selected image will also be considered a match.

The received image (associated with the request, not the pre-selected image) will be subjected to the same process outlined and described above in order to generate a matrix (e.g., B′, similar to A′ discussed above) and vector therefore. Such steps are outlined at reference numerals 408, 410 and 412 of FIG. 4.

The similarity between the vectors of the image associated with the request and the pre-selected image may be determined by calculating a similarity coefficient for the images. In an example, the similarity coefficient is calculated using i) the vector and the length of the vector of the pre-selected image, and ii) a vector and a length of the vector of the submitted image (as shown by reference numeral 414 in FIG. 4). More particularly, the similarity coefficient is calculated by the dot product of the vectors:

$$cos θ = \frac{〈 a , b 〉}{‖ a ‖ ‖ b ‖} . \qquad ( Eqn . 2 )$$

where a, b are the vectors for the image and the pre-selected image, respectively.

The calculated similarity coefficient is then compared to a predetermined threshold (as shown by reference numeral 416 in FIG. 4). The predetermined threshold is a coefficient (identified by an angle on a vector plot), selectable by the call center 24, that allows the call center 24 to determine to what degree the image and the pre-selected image are similar. For example, if the predetermined threshold is selected to be 5 degrees, then any angle between the vectors (i.e., the vector of the pre-selected image and the image associated with the request) within 5 degrees is considered to be similar. On the other hand, if the predetermined threshold is selected to be 50 degrees, then the angle between the vectors may be larger (indicating more differences between the images), but still may, in some instances, be considered similar enough for purposes of identifying the user request. Generally, it will be more desirable for the predetermined threshold to be less than 50 degrees. In a non-limiting example, the predetermined threshold ranges from about 5 degrees to about 25 degrees.

It is to be understood that the threshold value may be adaptive in the sense that the threshold value may be adjusted based, at least in part, on historical information stored at the call center 24. For example, the call center 24 may include a bank or database 72 of threshold values previously used to make the image/pre-selected image comparison. Such information may be used to adjust and/or tailor the threshold value so that subsequent comparisons may produce more accurate results.

In binary terms, if the similarity coefficient is 1, the vectors of the pre-selected image and the image associated with the request are identical, and the action associated with the pre-selected image is identified as the request. If the similarity coefficient is 0, the vectors of the pre-selected image and the image associated with the request are identical, and the action associated with the pre-selected image is identified as the request.

In instances where the similarity coefficient exceeds the predetermined threshold value, the call center 24 is unable to identify the user request (as shown by reference numeral 418). In such instances, the call center 24 may select another pre-selected image from the user profile 104 and determine a new similarity coefficient between the submitted image and the newly selected pre-selected image. The call center 24 may be configured to repeat this process using each pre-selected image in the user profile 104 until the call center 24 i) finds a match, or ii) determines that there is no pre-selected image in the user profile 104 similar to the submitted image. If the call center 24 finds that there is no pre-selected image in the user profile 104 that is similar to the image associated with the request, the call center 24 may send a response back to the user who submitted the image notifying the user that the request could not be identified. In an example, the notification may also be accompanied with a request, from the call center 24, for the user to submit a new image if he/she desires. If the user does in fact submit a new image, the user may be re-authenticated by the call center 24.

In instances where the similarity coefficient is less than the predetermined threshold, then the user request is identified from the action associated with the pre-selected image (as shown by reference numeral 420 in FIG. 4). This may be accomplished by the call center 24 retrieving the action associated with the matched up pre-selected image (e.g., image 110_{A}) from the user profile 104. The call center 24 thereafter fulfills the user request by triggering the action. Triggering of the action may be accomplished by providing the requested vehicle information, the requested vehicle service, and/or the requested vehicle diagnostics to the user making the request.

While several examples have been described in detail, it will be apparent to those skilled in the art that the disclosed examples may be modified. Therefore, the foregoing description is to be considered exemplary rather than limiting.

1. A method for determining a user request, comprising:
receiving an image at a call center;
generating a mathematical representation associated with the image;
retrieving a previously stored mathematical representation associated with a pre-selected image, wherein the pre-selected image corresponds with an action; and
using the image mathematical representation and the pre-selected image mathematical representation to identify a user request that is associated with the image.

2. The method as defined in claim 1 wherein prior to receiving the image at the call center, the method further comprises:
selecting the pre-selected image;
associating the pre-selected image with the action; and
storing, at the call center, the pre-selected image and the action in a user profile.

3. The method as defined in claim 1, further comprising:
including user identification information with the image received by the call center, the user identification information being associated with a vehicle; and
identifying the vehicle corresponding to the image based on the user identification information.

4. The method as defined in claim 1 wherein after receiving the image, the method further comprises:
requesting, from a sender of the image, user identification information; and
identifying a vehicle corresponding to the image based on the user identification information.

5. The method as defined in claim 1 wherein the generating of the mathematical representation associated with the pre-selected image is accomplished by:
retrieving an original encoded matrix of the pre-selected image;
generating a vector based on the original encoded matrix of the pre-selected image;
calculating a length of the vector; and
storing the vector and the length of the vector in a user profile at the call center.

6. The method as defined in claim 5 wherein retrieving the original encoded matrix of the pre-selected image is accomplished using encoding and decoding processes.

7. The method as defined in claim 5 wherein the generating of the mathematical representation associated with the image is accomplished by:
retrieving an original encoded matrix of the image;
generating a vector based on the original encoded matrix of the image; and
calculating a length of the vector.

8. The method as defined in claim 7, further comprising:
calculating a similarity coefficient based on the calculated length of the vector of the image and the pre-selected image;
comparing the similarity coefficient with a predetermined threshold; and
if the similarity coefficient is less than the predetermined threshold, identifying the user request.

9. The method as defined in claim 1 wherein the user request is selected from an information request, a vehicle service request, and a vehicle diagnostics request.

10. The method as defined in claim 1 wherein if the pre-selected image is a portion of a vehicle, then the image includes the same portion of the vehicle or the same portion of an other vehicle.

11. The method as defined in claim 1 wherein the pre-selected image is a portion of a vehicle or an other object.

12. The method as defined in claim 1, further comprising fulfilling the user request by triggering the action.

13. A system for determining a user request, comprising:
a call center configured to receive an image; and
a processor operatively associated with the call center, the processor configured to:
generate a mathematical representation associated with the image;
retrieve a previously stored mathematical representation associated with a pre-selected image, wherein the pre-selected image corresponds with an action; and
use the image mathematical representation and the pre-selected image mathematical representation to identify a user request that is associated with the image.

14. The system as defined in claim 13, further comprising a telematics unit operatively disposed in a vehicle associated with the received image, the telematics unit configured to fulfill the user request.

15. The system as defined in claim 13 wherein the image is an mms image including at least one or more features of the pre-selected image.

16. The system as defined in claim 13, further comprising a user profile stored at the call center, the user profile including the pre-selected image.

17. The system as defined in claim 13 wherein the image further includes user identification information, the user identification information authenticating a sender of the image.

18. The system as defined in claim 13 wherein the pre-selected image is selected from a portion of a vehicle and an other object.

19. The system as defined in claim 13 wherein the image is selected from a portion of a user vehicle, a portion of an other vehicle, and an other object.

20. The system as defined in claim 13, further comprising means for fulfilling the user request by triggering the action.
